(19) United States
(12) Patent Application Publication
(10) Pub. No.: US 2009/0138527 A1
(43) Pub. Date: May 28, 2009

(54) PORTABLE DATA RECOVERY APPARATUS AND METHOD

(76) Inventors: Tadashi Honda, Yokohama (JP); Ronald Finne, Tokyo (JP)

Correspondence Address: LAWRENCE S. COHEN, ESQ.;LAW OFFICE OF LAWRENCE S. COHEN, 10960 WILSHIRE BLVD, SUITE 1220, LOS ANGELES, CA, 90024, US

(21) Appl. No.: 12/249,846

(22) Filed: Oct. 10, 2008

Related U.S. Application Data
(60) Provisional application No. 61/004,122, filed on Nov. 24, 2007.

(51) Int. Cl. G06F 12/02; G06F 12/00; G06F 12/16

(52) U.S. Cl. 707/202; 707/205

(57) ABSTRACT

Data recovery operations on corrupted computer equipment now commonly accomplished by bringing the computer to a laboratory are carried out by a portable unit at the computer site. The imposed restriction of data transfer to or from a hard drive in the portable unit precludes data from reaching any destination other than the originating data store or the unit hard drive. The unit is operative, in the field, to service a sequence of corrupted data memories in a number of computers by constraining data transfer in each instance solely between the originating data memory and the designated file in the hard disk of the portable unit.

### RELATED APPLICATIONS

This application claims priority from U.S. Provisional Application Ser. No. 61/004,122 filed on Nov. 24, 2007 the content of which is incorporated herein by reference.

### FIELD OF THE INVENTION

This invention relates to apparatus for the recovery of compromised data in a computer system and more particularly to such apparatus which is portable.

### BACKGROUND OF THE INVENTION

Data recovery operations are frequent occurrences for computer systems due often to disk crashes, worms, unauthorized access—etc. Elaborate security arrangements are normally employed to limit access for different data security levels to limit the potential for data loss or compromise. Still, when data loss or corruption occurs, the result could be catastrophic. Not only is data recovery action necessitated, but also secure movement of the data is paramount.

At present, when data in a computer memory is corrupted, remediation often requires that at least parts of the computer such as a hard drive be taken off site to a facility with the equipment to reboot the computer and transfer the data to different data store.

### SUMMARY

In accordance with the principles of this invention, data recovery apparatus is self-contained within a portable envelope and includes software for booting up a computer and recovering compromised data in the computer memory. The ability to move remediation equipment into the field rather than requiring the computed data in a laboratory setting depends on the capability of being able to maintain the data in a reliable secure environment.

In accordance with the principles of this invention, a portable data recovery unit having a hard drive or memory is operative in a manner such that data recovered from a corrupted memory can only be moved to the hard drive on the portable unit and vice versa, any movement from the hard drive to the original data memory can only operate to move the data to the hard drive in the portable unit.

The exclusion of all other possible destination for data movement is achieved, for example, by recording the serial number of the hard drive in the portable unit and the serial number of the hard disk (the original data store) in the corrupted computer. Any instruction to move data from the portable unit or the original data store is accompanied by a destination code. A comparator, activated by a “transfer data” command compares the destination code to the serial number of the hard disk in the portable unit. If no match occurs, transfer of data is denied. For data transfer out of the hard disk, the comparator compares the destination code with the serial number of the data store in the corrupted computer. If no match occurs, data transfer is denied.

The use of the originating data memory store serial number and the serial number of the hard disk in the portable unit as identifiers ensures that the data is secured and cannot be transferred to an unauthorized data memory store. Data from the hard drive on the portable unit can only be transferred back to the originating memory.

This security regimen permits the portable unit to, for example, interact with a number of computers in a given facility, establishing a file in the hard disk of the portable unit for each computer. In this case, each file has the serial number of the data store in the corresponding computer. Thus, data transfer from that file can only occur to a destination with a serial number which matches the serial number of the originating data store.

A portable unit, programmed to perform the data recovery operations common for in-laboratory equipment, can service a number of computers, on site, by connecting, for example, to the USB Port of a computer, downloading the program to initiate remediation of the data, disconnecting and repeating the operation with each of the remaining computers.

Again although downloaded data from each of the (corrupted) computers to corresponding files in the hard drive in the portable unit can only be moved from that hard drive to the data store with the originating serial number.

### BRIEF DESCRIPTION OF THE DRAWINGS

FIG. 1 is a block diagram of a portable unit for data recovery;

FIG. 2 is a block diagram of the unit of FIG. 1 connected to a computer with a corrupted data store.

FIG. 3 is a block diagram of the software for controlling data movement between a corrupted data memory and a hard drive in the portable unit of FIG. 1;

FIG. 4 is a block diagram of the unit of FIG. 1 operative to transfer data between a file in the hard drive of the unit and each of a plurality of corrupted data stores in a plurality of computers; and

FIG. 5 is a block diagram of the software for the secure transfer of data between the files of the hard drive of the unit of FIG. 1 and the data stores in corresponding ones of a plurality of computers to which the unit is connected in sequence.

### DEFINITIONS

Unit: A device containing at least an OS, data memory, standard interface for data processing, circuits to perform required functioning as is common in data recovery units.
Corrupted Data: Data that are not readable correctly due to logical and/or physical problems of the storage unit in the computer.
Crashed Computer: A computer that cannot function correctly. Causes include physical damage, logical damage, etc.
Booting: The action of starting an operating system.
Remediation Equipment: A unit useful to start and run operational/non-operational computers using the unit's OS, and to run various software application programs.
Protected Memory: Memory addresses that cannot be accessed using standard hardware and software.
Connection: A data transfer mechanism comprising, for example, a USB interface on the unit and on the computer and a cable, and/or another data transfer means.
Identifier: Data that are contained in memory and are specific to one piece of hardware equipment such as a hard disk drive or are characteristic of a data set such as an OS registration number which can be stored in protected memory.

### DETAILED DESCRIPTION OF ILLUSTRATIVE EMBODIMENTS OF THIS INVENTION

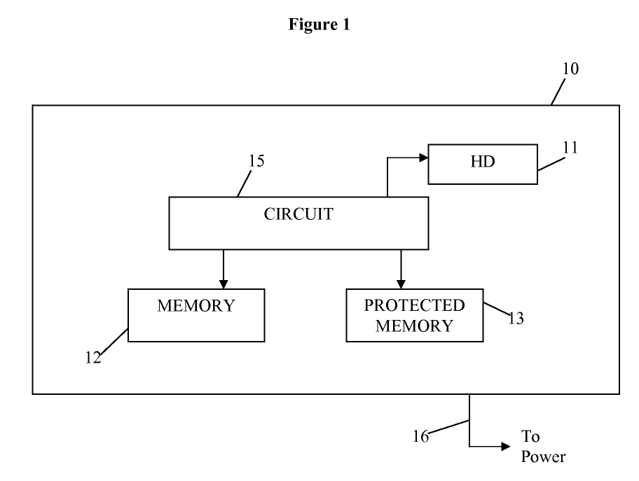

FIG. 1 is a block diagram of a portable unit 10 in accordance with the principles of this invention. The unit includes a hard drive 11, a memory 12, a protected memory 13 and a control circuit 15. The unit is shown with a cable 16 for connection to a separate power supply, for example, an in the wall supply or through a computer to which it connected.

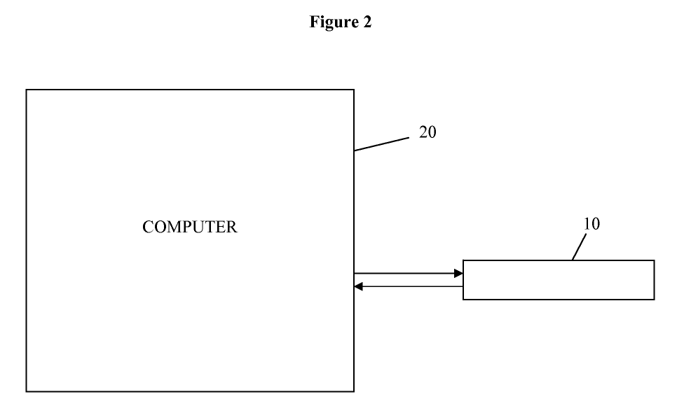

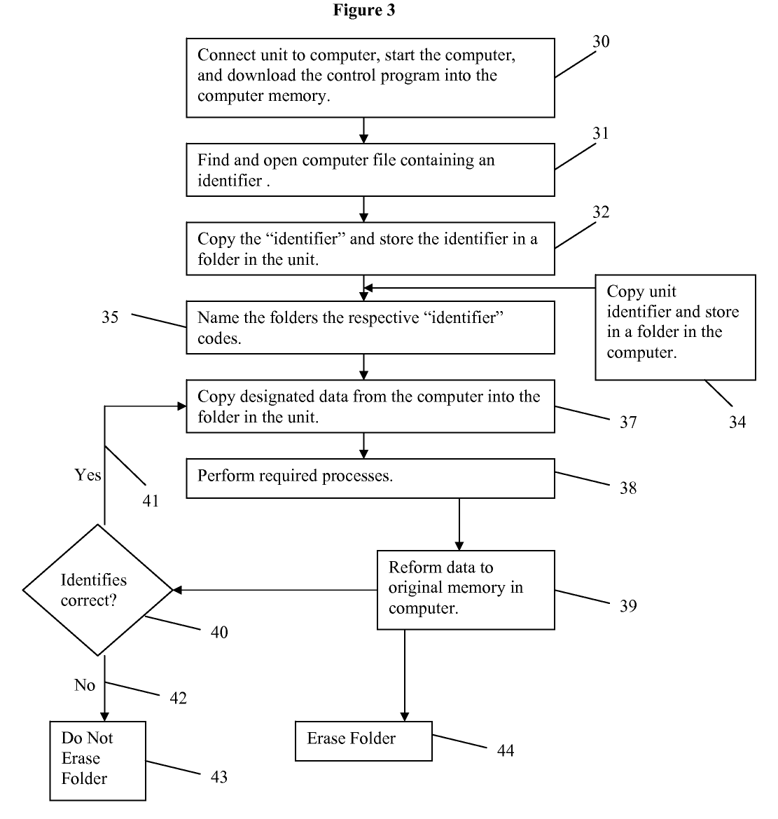

FIG. 2 shows the unit 10 of FIG. 1 connected to a computer 20. FIG. 3 is a flow diagram of the interaction between the unit 10 and a computer 20 shown in FIG. 2.

Specifically, in reference to FIG. 3, unit 10 is connected to a computer, starts the computer and downloads the control program into the computer memory as indicated by block 30. The program in this connection is operative to perform the functions commonly performed by taking a computer to a laboratory for addressing operation problems. Such software is available in commercial products and services available, for example, from Advanced Design Corporation of Kawasaki, Japan.

The program next operates to open a file in the computer containing an identifier as indicated by block 31. The identifier is copied and stored in a portion of the memory designated the “folder” in, for example, the protected memory 13 in the unit 10 of FIG. 1 as represented in block 32.

The next step is to copy the unit identifier, which preferably is the serial number of hard drive 11, and store the identifier in a folder in the computer 20 as indicated by block 34. Each folder is named in unit 10 with the corresponding identifier code as indicated by block 35 for situations where a plurality of computers is being serviced simultaneously by a unit 10 as will become clear hereinafter.

The next step is to copy the designated data in the computer into a folder in the unit 10 (in association with the computer identifier). This step is indicated by block 37. The transferred data is now secured and is incapable of being transferred out of the unit except to the memory in the computer with the identifier defined in block 32.

Unit 10 and the computer can now perform the required operations as indicated by block 38 in FIG. 3. As stated hereinbefore, the required processing is substantially as is performed by prior art commercial equipment and is not discussed further herein. The present invention is directed at ensuring that data transfer between a computer and a unit is secure when the unit is portable and moved from computer to computer.

When the processing is completed data may be returned to the original computer. The return destination is to the memory in the computer which has the designated identifier. This step is represented by block 39.

If the unit is connected to a computer with the correct identifier, the data are returned, as indicated by block 40 and arrow 41, to the originating file as indicated by block 37. If a wrong identifier is indicated, no transfer occurs as indicated by block 43 and arrow 42.

The processing terminates and the data in the folder in the unit may be erased as indicated in block 44.

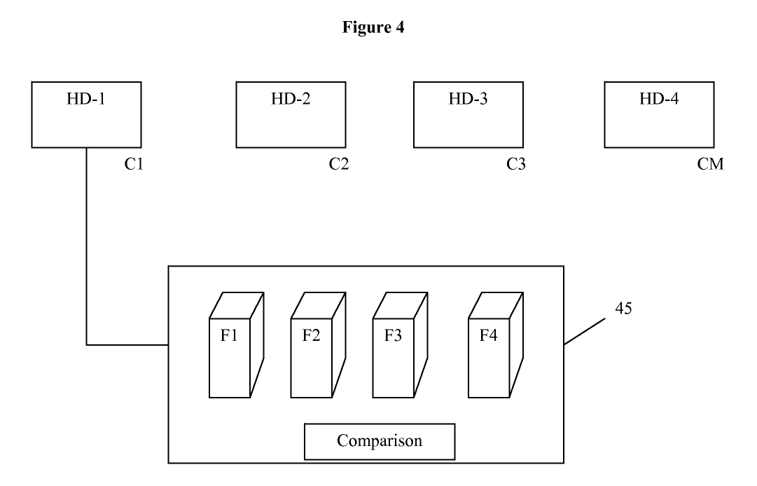

FIG. 4 shows a portable unit 45 connected to a first of a plurality of computers C1, C2, C3 - - - CM. The operation of the unit with each of computers is the same as described above except that a separate folder with a separate computer identifier is created in the unit 45. Thus, for computer C1 a file f1 is created in the unit 45 with computer C1 identifier. The unit identifier is stored in computer C1 protected memory. Because of the reciprocal identifier storage, data from the unit can be transferred only to computer C1. Also, if the unit is disconnected from computer C1, for example, while programs are still being executed, any data in computer C1 which may later be required by unit 45 can only be transferred to that unit (with the proper identifier) and to no other unit. Thus when unit 45 downloads programs into each of a plurality of computers (C1, C2 - - - ) in sequence, any data being processed by a computer (C1, C2 - - - ) could be accessed by no unit other than the unit with the identifier stored in the folder. Each computer (C1, C2 - - - ) has a unique identifier to this end determined as discussed in connection with FIG. 3.

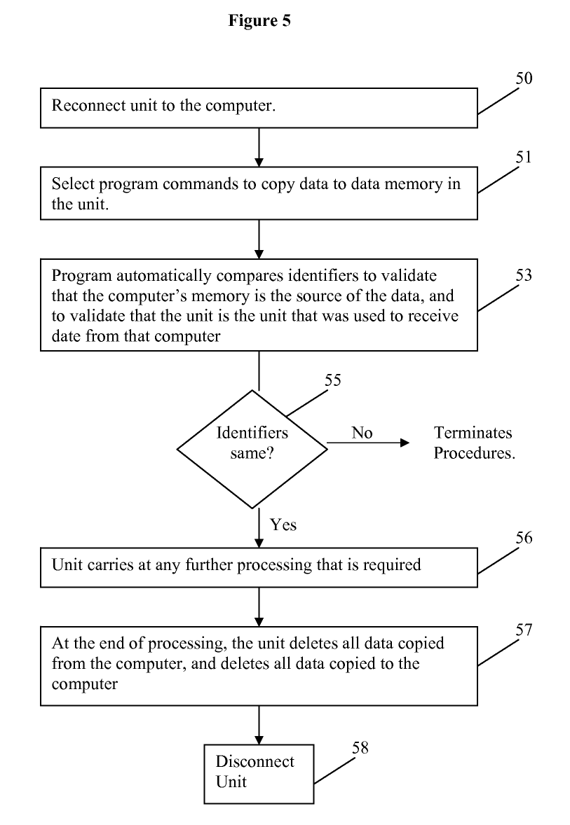

Because of the security system described in accordance with the principles of this invention, a unit 45 can be reconnected to a computer from which it had been disconnected with the confidence that the identical unit is being reconnected. FIG. 5 is a flow diagram of the reconnect regimen.

When the unit is reconnected as indicated by block 50 of FIG. 5, if, for example, computer C1 has indicated that processing is completed, reconnection of the unit results in automatic restoration of data to the computer C1 folder and erasure of any residual data in the corresponding file F1 in unit 45. If processing is incomplete, the unit operator selects a program to command copy of data from computer C1 to the data memory in unit 45 as indicated by block 51.

The program automatically validates that the computer identifier and the unit identifiers are correct as indicated by block 53. If the identifiers correspond to the identifiers when previously connected (block 55), the unit 45 carries out any further processing required as indicated by block 56. If they are not the same, the connection is terminated.

When processing is complete, all data transferred to the unit may be erased and all data copied from the computer are deleted and the unit is disconnected as indicated by blocks 57 and 58.

In summary, a control unit is used to run various programs on two or more computers simultaneously while ensuring that data from a particular computer can only be transferred between that computer and the control unit running programs on that computer.

Specifically, the control unit is prevented from transferring data to a data memory other than the one from which the data were originally transferred to the control unit.

The unit is connected to a computer and downloads a program into the computer's memory so that the computer can be controlled using the unit's operating system (OS).

The unit copies the unit's identifier into the computer's memory and also records the computer's memory identifier into the unit's memory. The program then starts required processes, creates/stores data needed for operation/documentation and record keeping. Such data in the unit are linked by data codes to the specific computer being processed.

The unit is disconnected from the computer and the computer memory identifier that is stored in the unit is preserved. The unit identifier is preserved in the computer memory. If the program stops, reconnection is required with the original unit.

In the event that the control unit is connected to another memory device, the unit's program automatically compares that memory's identifier with the identifier in the unit's protected memory. Since there will not be a match, data transfer will not occur.

In the event of a problem, an error message is sent from the computer to the designated computer. The unit that was originally used to start the process on that computer is taken back and reconnected to the computer, and appropriate measures are taken to solve the problem.

On completion of the required processing steps, the computer indicates completion on its display. The unit is taken to that computer and reconnected. In order to maintain process continuity and prevent leakage of data to an unauthorized unit or computer the following steps are taken.

The computer confirms, by comparing identifiers that this unit is the unit used to start the process and to which data had been transferred.

The unit confirms by comparing identifiers that this is the computer from which data were originally transferred.

Process documentation is transferred to and/or created by the unit and stored in the suitable unit memory.

It is to be understood that although the description herein is in terms of hard drives, it is only illustrative. It is contemplated that memories other than hard drives can be used in accordance with the principles of the invention such as flash memories, optical memories - - - etc, and these will have characteristic serial numbers or can be so designated. Also, it is contemplated that in a facility with a plurality of computers serviced by the server, the unit herein can be connected to the server for interacting with the individual computers as discussed above. Also, although the invention is described in terms of storing in a unit the identifier for a computer to which it is connected and storing in the computer the serial number of the unit which is the most secure embodiment. In some instances only the computer identifier need be stored in the unit.

What has been described herein is considered merely illustrative of the principles of this invention and it is within the purview of those skilled in the art to devise various modifications thereof within the spirit and scope of the invention as encompassed by the following claims.

What is claimed is:

1. A method of secure return of data from a first file in a computer memory only to a memory from which the data was originally transferred, said method comprising storing in said file the serial number of the originating memory, comparing with the serial number the destination of each command to transfer data from the file and permitting transfer only if a match occurs between the serial number and the destination code.

2. A method of ensuring that data transferred from a first memory device to a second memory device can be transferred out of the second memory device only back to the first memory device, the method comprising storing the serial number of the first memory device in said second memory device in association with the initial data transfer, comparing the destination code of any data transfer command from the second memory with the stored serial number and permit data transfer only when a match occurs.

3. A method for transferring data from each of a plurality of computers with a portable unit movable from one computer to another, said unit having a memory with plurality of files, said method comprising connecting the unit to each of the computers in sequence and carrying out with each of the computers before disconnecting and moving on to the next the steps of storing the serial number of the computer hard drive in the unit memory in association with a designated file and transferring the data in the hard drive the designated file in the unit memory and permitting data transfer out of the designated file only when transfer is to a hard drive with a serial number which matches the serial number stored in association with the designated file and erasing the associated serial number when data transfer out of the designated file occurs.

4. The method of ensuring the secure return of data transferred from the hard drive of a computer to a data recovery unit. The method comprising connecting to the USB port of the computer a unit comprising a second hard drive and a protected memory, storing in the protected memory the unique serial number of the computer hard drive, storing the transferred data in the second hard drive in association with the serial number of the computer hard drive, and permitting data transfer from the second hard drive only to an address associated with the serial number of the computer hard drive.

5. Apparatus for providing secure data transfer between a computer memory and a portable unit having a protected memory where the unit is connected to the computer and is adapted to carry out various processes on data in the computer, said apparatus comprising means for storing in the computer the serial number of the hard drive in the unit, and means for storing in said protected memory the identifier for the memory in the computer.
